(19) United States
(12) Patent Application Publication
(10) Pub. No.: US 2024/0007259 A1
(43) Pub. Date: Jan. 4, 2024

(54) FREQUENCY-DOMAIN REALLOCATION IN WIRELESS-WIRELINE PHYSICALLY CONVERGED ARCHITECTURES

(71) Applicant: PHYTunes, Inc., Palo Alto, CA (US)

(72) Inventors: Akula Aneesh REDDY, San Jose, CA (US); Jisung OH, Palo Alto, CA (US); Vinay JOSEPH, KERALA (IN)

(73) Assignee: PHYTunes, Inc., Palo Alto, CA (US)

(21) Appl. No.: 17/853,089

(22) Filed: Jun. 29, 2022

(51) Int. Cl. H04L 5/00; H04B 3/32

(52) U.S. Cl. CPC H04L 5/0092; H04B 3/32; H04L 5/006

(57) ABSTRACT

Embodiments of the present invention provide systems, devices and methods for improving the performance and range of wireless-wireline communication systems. In certain examples, the architecture leverages pre-existing copper within a building to allow a signal to traverse physical barriers, such as walls, on copper wire while using wireless portions of the channel to communicate signals in air both outside and inside the building. Reallocation of spectrum within this architecture is performed across various embodiments to improve performance and decrease signal attenuation and interference.

### BACKGROUND

### A. Technical Field

The present invention relates generally to telecommunication systems, and more particularly, to wireless and wireline communication architectures that improve use of converged architectures with multiple wireline cables with different wireline cables for different locations/users. The enhancements enable higher throughputs for a given wireline infrastructure and support for wireline infrastructure with long cables.

### B. Background of the Invention

One skilled in the art will understand the importance of wireless communication systems (including LTE, 5G, 5GNR and Wi-Fi architectures) and the complexity of these systems as they are built-out and maintained around the world. As the complexity of these systems increases and the resources available to them are allocated across an increasingly higher frequency spectrum, the management of wireless channels becomes more challenging. For example, a cellular base station must manage a large number of channels in communicating with UEs (User Equipment) devices within its cell while the characteristics of these channels are constantly changing. This management of channels becomes more challenging in dense cities in which wireless signals must traverse a variety of physical barriers to reach a UE such as a cellphone. This channel quality and range issue is particularly problematic when channel frequencies increase and are more sensitive to interference, noise and varying channel properties.

Cellular subscriber lines (hereinafter, “CSL”) employ the novel concept of using the existing wireline infrastructure (e.g., telephone lines, fiber-optic cables, Ethernet wires, coaxial cables) in conjunction with the wireless infrastructure to extend the coverage of wireless signals quickly, inexpensively, and securely.

The architecture of the cloud-based cellular subscriber line intermediate frequencies (hereinafter, “CSL-IF”) and consumer subscriber line radio frequencies (hereinafter, “CSL-RF”) networks is illustrated in FIG. 1, which shows two low-cost units at the two ends of the wireline connection: the CSL-IF unit IF-modulates the wireless baseband signal and transmits the modulated signal to a CSL-RF unit at the other end of the wire. The CSL-RF unit up-converts the signal for wireless transmission to nearby client devices, such as IoT devices and smartphones. The CSL-IF unit is interfaced with a baseband unit (hereinafter, “BBU”) located at a cell-tower or at a central office of the CSP. The CSL-IF unit generates baseband digital streams from the BBU output (downlink) and converts the baseband digital streams to specific O-RAN split signals for the BBU input (uplink).

The wireline medium or cable connecting CSL-IF and CSL-RF units impacts CSL's performance. The cable is used for sending IF-modulated baseband signals to CSL-RF and CSL-IF sends received uplink samples after down-converting from radio frequency range to intermediate frequency. Within this CSL architecture, managing bandwidth usage across the various links is a problem. Specifically, a resource block scheduler will primarily schedule uplink and downlink transmission from the perspective of wireless communication. However, as this scheduling is mapped onto wireline media, bandwidth issues may become problematic as transmitted resource blocks are communicated on the wireline.

Accordingly, what is needed are systems, devices and methods that address the above-described issues.

### SUMMARY OF THE INVENTION

Embodiments disclosed herein are systems, devices, and methods that can be used to provide improved performance (e.g., data rate, quality of service, etc.) on networks that include both point-to-point communication links and point-to-multipoint/multipoint-to-point communication links. As just one example, the systems, devices, and methods described herein can be used in wireless-wireline physically converged architectures.

These embodiments improve wireless communication systems using wireline communication systems. For example, the systems, devices, and methods described herein can be used to perform frequency-domain or time-domain reallocation of wireless baseband signals for enhancing wireless-wireline physically converged architectures. In some embodiments, frequencies of baseband signals transmitted over a plurality of wireline media are reallocated jointly, and the reallocation associated with each wireline medium is aimed at reducing the attenuation experienced by a specific subset of signals useful/available to devices utilizing that wireline medium. The reallocation may include shifts of frequencies in the baseband signals and/or suppression/removal of non-useful parts of the signal.

As will be appreciated by those having ordinary skill in the art, the frequency band in which a signal is transmitted over a channel depends on a number of factors, including the characteristics of the communication medium over which the signal will be transmitted (e.g., how much the channel attenuates signals at various frequencies). Moreover, and as will also be appreciated by those having ordinary skill in the art, baseband signals (e.g., signals having components at frequencies that are close to zero) can be transmitted at baseband if the communication channel is suitable.

Baseband signals generated/processed at baseband can alternatively be upconverted for transmission/reception in a higher-frequency band as passband signals. Depending on a passband signal's location within the spectrum relative to the frequencies of other signals in the system, a passband signal may be referred to as a radio-frequency (RF) signal or as an intermediate-frequency (IF) signal. By convention, IF signals are in lower frequency bands than RF signals. An RF signal can be created by upconverting an IF signal, and an IF signal can be created by down-converting an RF signal. The up-conversion and down-conversion can be accomplished in any number of ways, using various well-known hardware components (e.g., mixers, local oscillators, amplifiers, etc.).

In this document, the disclosures are presented in the context of, but are not limited to applications that use, the cellular subscriber line (CSL). Concepts related to the CSL are described in “Wireless-wireline physically converged architectures,” U.S. Patent Publication No. 2021/0099277 A1; and J. M. Cioffi et al., “Wireless-wireline physically converged architectures,” WIPO Patent Publication No. WO2021/062311, both of which are hereby incorporated by reference in their entireties. CSL systems use the existing wireline infrastructure (e.g., telephone lines, fiber-optic cables, Ethernet wires, coaxial cables, etc.) in conjunction with the wireless infrastructure to extend the coverage of wireless signals quickly, inexpensively, and securely. CSL systems can include hardware and/or software components to transmit and/or process signals at a variety of frequencies, including RF and IF.

Certain features and advantages of the present invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

Figure (“FIG.”) illustrates a CSL cloud-based architecture that includes CSL-IF and CSL-RF units coupled to each other by a cable (e.g., twisted pair, coaxial cable, etc.).

FIG. 2 illustrates that higher frequencies experience more attenuation in cables, longer cables introduce more attenuation than shorter cables, and attenuation properties are impacted by the type of cable (e.g., CAT5e, coaxial, etc.).

FIG. 3 illustrates a CSL architecture in which a CSL-IF is coupled to a plurality of CSL-RF units according to various embodiments of the invention.

FIG. 4 is a diagram showing the transmission of downlink baseband signals from the CSL-IF unit to the CSL-RF unit according to various embodiments of the invention.

FIG. 5 illustrates modified transmission of downlink baseband signals from the CSL-IF unit to a CSL-RF unit according to various embodiments of the invention.

FIG. 6 illustrates an example of frequency reallocation involving a CSL-IF unit that is in communication with three CSL-RF units according to various embodiments of the invention.

FIG. 7 is a block diagram of a CSL-IF unit according to various embodiments of the invention.

FIG. 8 is a block diagram of a CSL-RF unit according to various embodiments of the invention.

### DETAILED DESCRIPTION OF THE PREFERRED EMBODIMENTS

Embodiments of the present invention provide systems, devices and methods for addressing interference and scheduling resource blocks within a wireless and wireline architecture across various channels within the system. In certain examples, the architecture leverages pre-existing copper within a building to allow a signal to traverse physical barriers, such as walls, on copper wire while using wireless portions of the channel to communicate signals in air both outside and inside the building. Reallocation of spectrum within this architecture is performed across various embodiments to improve performance and decrease signal attenuation and interference.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different electrical components, circuits, devices and systems. The embodiments of the present invention may function in various different types of environments wherein channel sensitivity and range are adversely affected by physical barriers within the signal path. Furthermore, connections between components within the figures are not intended to be limited to direct connections. Rather, connections between these components may be modified, re-formatted or otherwise changed by intermediary components.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

FIG. 1 illustrates a CSL cloud-based architecture 100 that includes CSL-IF 110 and CSL-RF 120 units connected to each other by a cable 130 (e.g., twisted pair, coaxial cable, etc.). The CSL-IF unit 110, which can be considered to be an intermediate transceiver, interfaces with a broadband unit (BBU) 140 (or, more generally, a base station) located, for example, at a cell-tower or at a central office of the cellular service provider (CSP). The CSL-IF unit 110 generates baseband digital streams from the BBU output (downlink direction) and converts the baseband digital streams to specific O-RAN split signals for the BBU input (uplink direction).

In the downlink direction (toward user equipment), the CSL-IF unit 110 receives baseband samples from the cellular radio access network (RAN), IF-modulates the wireless baseband signal, and transmits the IF-modulated signal over the cable to a CSL-RF unit 120 at the other end of the cable. The CSL-RF unit 120, which can be considered to be a distribution transceiver, then up-converts the signal to RF and transmits RF signals to user equipment (UE) (e.g., IoT devices, smartphones, etc.) within its range. Similarly, in the uplink direction (toward the BBU), the CSL-RF unit 120 receives RF signals from the UE, down-converts them to the IF, and transmits IF-modulated signals over the cable to the CSL-IF unit 110.

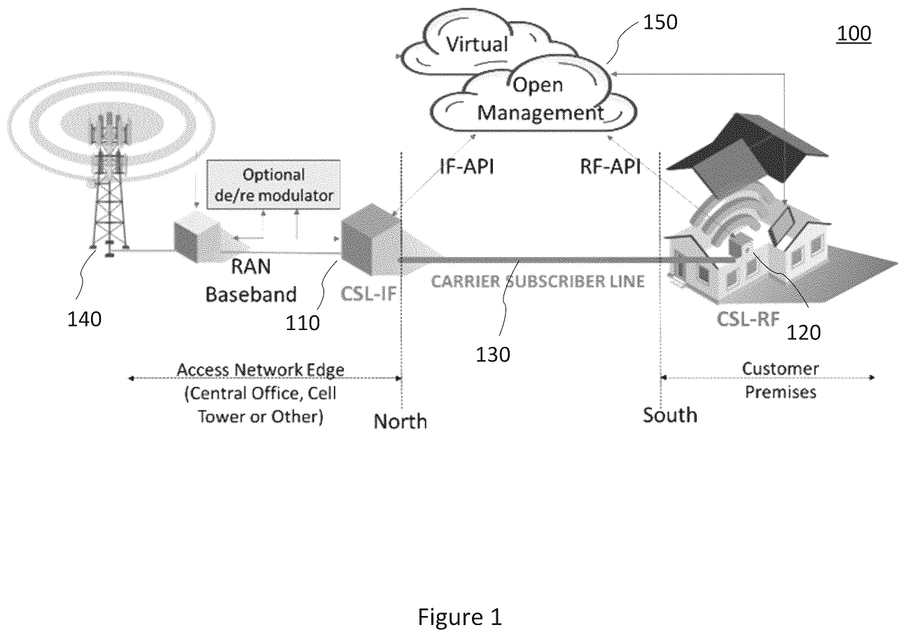

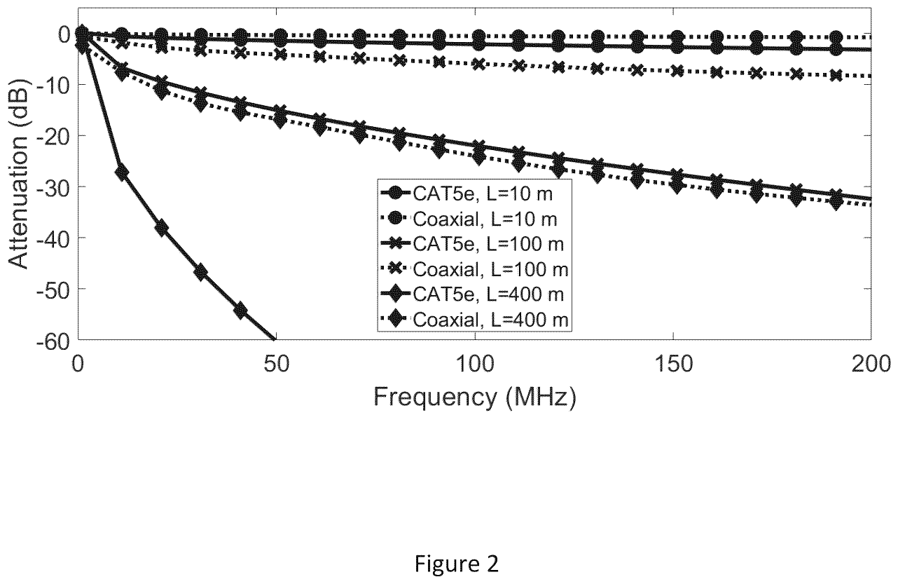

The wireline medium 130 (also referred to herein as a cable) that connects the CSL-IF 110 and CSL-RF 120 units allows the CSL-IF 110 to send IF-modulated baseband signals to the CSL-RF unit 120, and the CSL-IF unit 110 sends received uplink samples after down-converting from the radio-frequency range to intermediate frequency. The cable has an impact on the performance of the CSL system. For example, wireline communication (over the cable) is significantly impacted by cable attenuation, which is a function of cable length and frequency. FIG. 2 is a plot comparing the attenuations of 10-meter, 100-meter, and 400-meter CAT5e and coaxial cables. FIG. 2 illustrates that (1) higher frequencies experience more attenuation in cables, (2) longer cables introduce more attenuation than shorter cables, and (3) trends (1) and (2) are impacted by the type of cable (e.g., CAT5e, coaxial, etc.).

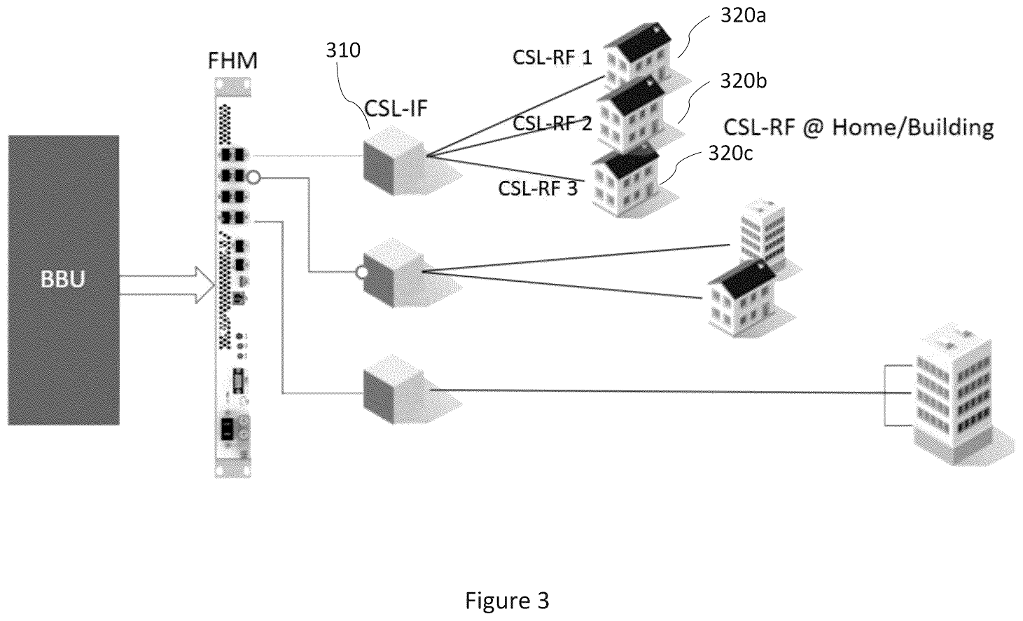

FIG. 3 illustrates another configuration in accordance with some embodiments. As shown in FIG. 3, multiple CSL-RF units 320 a-c can be coupled to a single CSL-IF unit 310. In such cases, in the downstream direction, a common downlink baseband band signal reaches the CSL-IF unit 310. After IF-modulation, the common downlink baseband band signal is sent to the individual to CSL-RF units 320 a-c. Thus, this architecture provides for point-to-multipoint (from a CSL-IF unit to multiple CSL-RF units) and multipoint-to-point (from multiple CSL-RF units to a single CSL-IF unit) communication.

When the CSL-IF unit 310 applies conventional IF-modulation to the baseband band signal to send it to the multiple CSL-RF units 320a-c over the respective communication channels connecting the CSL-IF unit 310 to the CSL-RF units 320a-c, the higher frequencies sent over each of the wireline media experience higher attenuation than the lower frequencies (refer to FIG. 2). Thus, if the resources allocated to a particular UE connected to a particular CSL-RF unit are at higher, rather than lower, frequencies, they will experience higher attenuation caused by the wireline medium connecting the CSL-IF unit 310 to the particular CSL-RF unit 320a than they would experience if they occupied lower frequencies. The higher attenuation may result in poor reception at the CSL-RF unit 320a, which could lead to poor wireless performance for the UEs connected to the CSL-RF unit (e.g., UEs may experience retransmissions, packet loss, higher delay, throughput reduction, and/or other negative effects). This performance degradation is typically more significant if the bandwidth of the baseband is high (e.g., 100 MHz) because, as shown in FIG. 2, the wireline attenuation increases with increasing frequency and will, in general, be higher at higher frequencies.

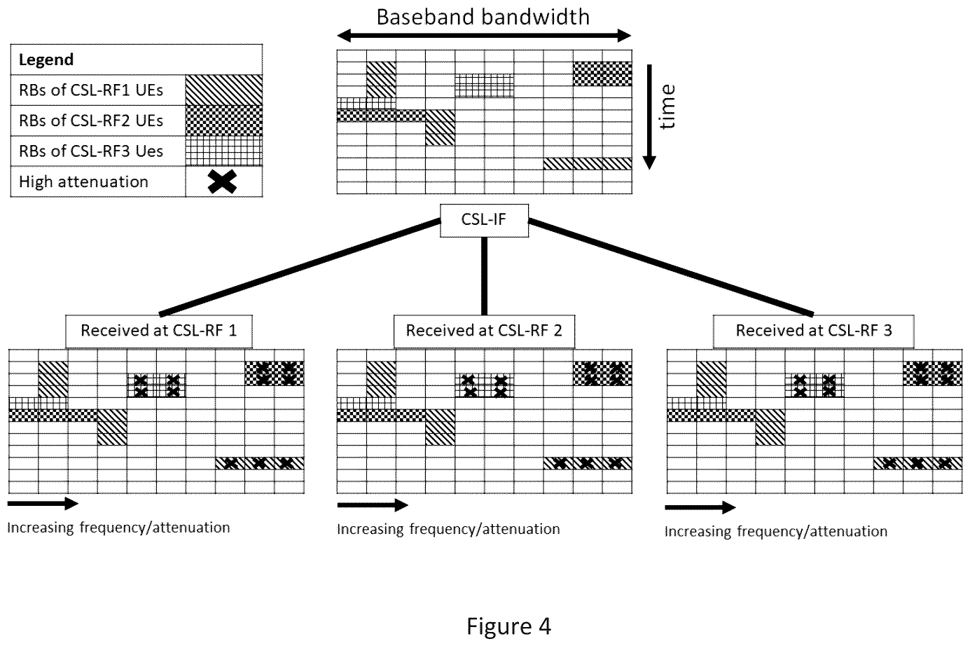

FIG. 4 is a diagram showing the transmission of downlink baseband signals from the CSL-IF unit to the CSL-RF unit in accordance with some embodiments in which the CSL-IF unit interfaces with a cellular system (e.g., as illustrated in FIGS. 1 and 3). As shown in FIG. 4, resource block (RB) allocation impacts the performances of the UEs connected to the CSL-RF unit 320a-c because higher-frequency RBs can experience much higher attenuation than lower-frequency RBs. If the resource allocation (e.g., RBs or resource elements (REs)) at the BBU is dynamic, meaning that it results in the allocation of higher frequencies to different UEs connected to different CSL-RF units at different times (e.g., use of the more attenuated frequencies is distributed to multiple UEs over time), the associated transmissions may be significantly impacted by the wireline attenuation caused by the cables between the CSL-IF 310 and CSL-RF units 320a-c. A degradation in performance may be experienced by different UEs at different times, depending on the allocation of the RBs to the UEs over time. Furthermore, these transient performance degradations could result in the selection of more conservative modulation and coding scheme (MCS) choices by the UEs, which, in turn, can result in lower long-term throughput for the UEs.

It should be noted that the issues associated with transmission over a cable are not prominent in wireless systems because the relative difference in attenuation between the lowest and highest RF frequencies for wireless communication will be much less than the differences for wireline communication (e.g., as illustrated in FIG. 2).

Thus, the result of a CSL-IF unit 310 sending the same baseband band signal to multiple CSL-RF units 320a-c simply by applying IF-modulation can be a poor wireless experience for at least some of the UEs connected to the CSL-RF units (e.g., UEs may experience retransmissions, packet loss, higher delay, throughput reduction, and/or other performance degradations). It is desirable to address this problem without changing the wireless systems involved or the existing wireline cable infrastructure. Specifically, it would be desirable to reduce the impact of substantially higher attenuation experienced by high-frequency RBs of a UE connected to a CSL-RF unit without changing the wireless systems involved or the existing wireline cable infrastructure.

Disclosed herein are systems and methods that take advantage of separate communication paths in a point-to-multipoint/multipoint-to-point architecture. Specifically, in the context of CSL, the frequency allocation of the separate wireline media between the CSL-IF unit and each CSL-RF unit is individually managed to improve the efficiency of the overall system. The disclosed techniques allow for higher throughputs for a given wireline infrastructure and provide support for wireline infrastructure with long cables.

In some embodiments, the CSL-IF unit 310 modifies the baseband signal it receives from the base station so that only the RBs that are associated with UEs of a CSL-RF unit are sent to and/or received from that CSL-RF unit over the wireline medium. This approach reduces the bandwidth consumed by wireline transmissions associated with each particular CSL-RF unit, because fewer RBs are transmitted to each CSL-RF unit (compared to the number of RBs that CSL-IF unit receives corresponding to all the UEs that the CSL-IF unit serves, which can include, for example, even microcell UEs). Reducing the bandwidth of the wireline transmission reduces the attenuation experienced by the transmission and thus improves performance.

Optionally, the RBs allocated to UEs of particular CSL-RF units can be restricted to a subset of the entire set of RBs, which can allow for a simpler CSL-IF unit implementation for downlink signals and a simpler CSL-RF unit implementation for uplink signals. Restricting the RBs allocated to UEs of the CSL-RF unit to a subset essentially results in a static or semi-static division of RBs among the CSL-RF units (or UEs associated with each CSL-RF unit). Information about a static or semi-static division can be provided via an overhead channel to the CSL-IF unit and the CSL-RF unit periodically or occasionally (e.g., at regular intervals or when needed). A static division can alternatively be a choice made when the system is designed, or it could be defined by a standard, a convention, an agreement, etc.

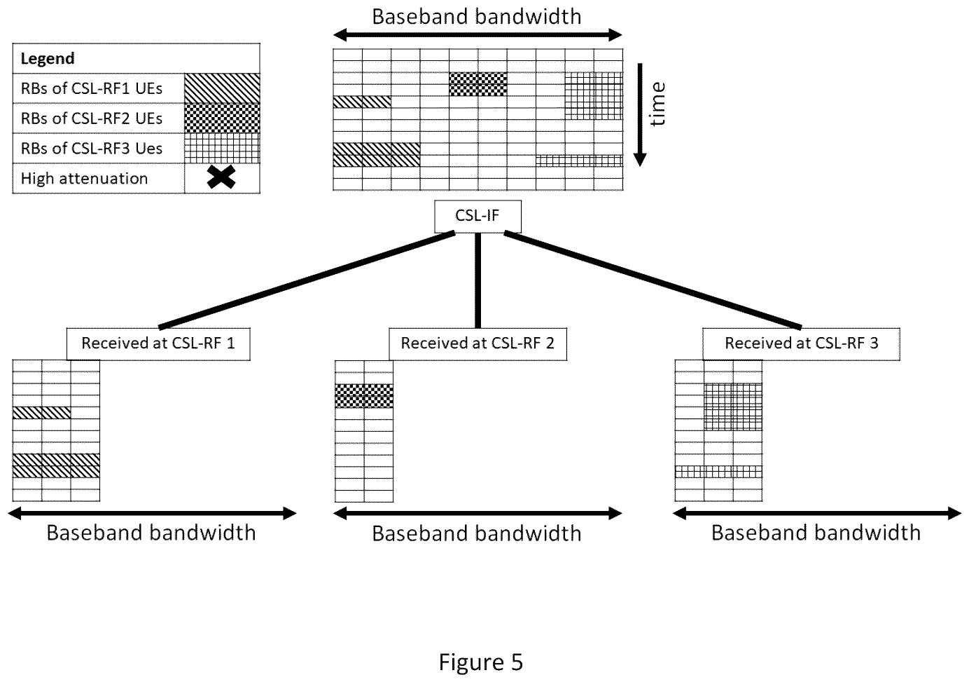

FIG. 5 illustrates how transmission of downlink baseband signals from the CSL-IF unit 310 to a CSL-RF unit 320a-c can be modified in accordance with some embodiments in which the RBs allocated to UEs of the CSL-RF unit are restricted to a subset of the entire set of RBs. As shown in FIG. 5, RB allocation has an impact on the performance of the UEs connected to the CSL-RF unit. Transmission of a subset of the entire set of RBs can also help increase the transmission power per RB in settings where there is a constraint on the total transmission power across all transmitted RBs.

It is to be understood that the approach described can be used without the optional static or semi-static division of RBs amongst CSL-RF units 320a-c. A suitably fast processing engine of the CSL-IF unit 310 (or external to it) can track the dynamic allocation of RBs to the UEs associated with the CSL-RF units 320a-c.

Regardless of whether the optional static or semi-static division of RBs is included, the division of RBs among the CSL-RF units can be done in different ways. As one example, an equal number of RBs can be allocated to each CSL-RF unit 320a-c. As another example, the allocation of RBs to CSL-RF units 320a-c can be done based on the wireless conditions of the UEs of each CSL-RF unit. The division of RBs may take into account the number of UEs connected to each of the CSL-RF units 320a-c and the traffic requirements of those UEs. As one example, a CSL-RF unit with no UEs (or no active UEs) may be assigned zero RBs, and CSL-RF units with large numbers of UEs, and/or UEs with high traffic requirements, and/or UEs subject to poor RF conditions may be assigned a relatively high number of RBs.

The identities of the RBs other than those associated with UEs of the CSL-RF units 320a-c may be transmitted by the RAN along with wireless control information (e.g., in a 5G context, in a master information block (MIB), system information block (SIB), or synchronization system block (SSB)).

The CSL-IF unit 310 is aware of the RBs used by UEs of the CSL-RF units 320a-c connected to it and is, therefore, able to perform the appropriate processing for downlink baseband signals. Information about the resource allocation (e.g., RB allocations) can be sent as side information from, for example, the wireless network (e.g., RAN, core, operations, administration, and maintenance (OAM), etc.) to the CSL-IF unit 310, e.g., via any intermediate node managing the CSL-IF unit.

The CSL-RF unit is aware of the RBs used by UEs connected to it, and therefore it is able to perform the appropriate processing for uplink baseband signals. Information about the resource allocation (e.g., RB allocations) can be sent as side information from, for example, the wireless network (e.g., RAN, core, OAM, etc.) to the CSL-RF unit, e.g., via any intermediate nodes managing the CSL-RF unit.

It may be desirable to avoid making information about RB allocation of UEs of the CSL-RF units available at the CSL-IF unit 310 and CSL-RF units 320a-c in order to avoid the transmission of side information. Accordingly, some embodiments provide for a RAN-transparent RB partitioning using a shift-based frequency reallocation. The downlink and uplink directions can be handled separately and independently. The shifts can by cyclic or non-cyclic. Frequency reallocations can alternatively be performed in other ways.

In some embodiments, in the downlink direction, the CSL-IF unit 310 transmits downlink baseband streams (received from the BBU) to some or all of the individual CSL-RF units 320a-c connected to it after reallocating the frequencies of RBs using an individualized frequency reallocation. In other words, the CSL-IF unit 310 shifts the frequency of some or all RBs, by a preferred frequency shift, that it transmits to some or all CSL-RF units 320a-c. The frequency reallocation for each CSL-RF unit 320a-c connected to the CSL-IF unit 310 may be different from all of the other reallocations so that different reallocations are used for different CSL-RF units connected to the CSL-IF unit. Before generating RF signals for transmission to UEs, each CSL-RF unit 320a-c can reverse the frequency reallocation performed for it by the CSL-IF unit 310 and thereby restore the RBs to their original locations in frequency as received by the CSL-IF unit from the BBU. The CSL-RF unit 320a-c can reverse the frequency reallocation by, for example, using a cyclic or non-cyclic shift that is the inverse of the one applied by the CSL-IF unit to “undo” the frequency reallocation performed by the CSL-IF unit.

A similar reallocation procedure may be performed in the uplink direction. In some embodiments, in the uplink direction, the CSL-RF unit performs a reallocation of RB frequencies using a frequency shift before sending uplink baseband signals to the CSL-IF unit. The CSL-IF unit can then reverse the frequency reallocation (e.g., using a cyclic or non-cyclic shift) to “undo” or reverse the CSL-RF unit's reallocation before merging uplink baseband signals from all CSL-RF units and sending the signals to the BBU.

By using frequency reallocation for transmissions over the wireline media, the CSL-IF and CSL-RF units can transparently improve the frequencies of the RBs sent over the wireline media so as to reduce the attenuation they suffer.

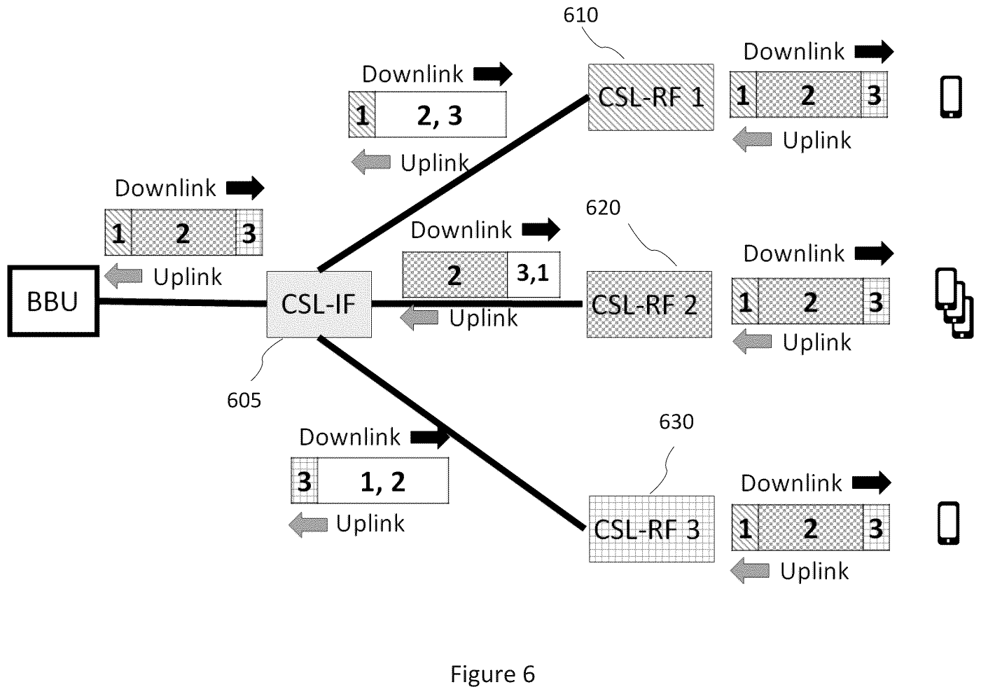

FIG. 6 illustrates a simple example of frequency reallocation involving a CSL-IF unit 605 that is in communication with three CSL-RF units 610, 620, 630, labeled “CSL-RF 1,” 610 “CSL-RF 2,” 620 and “CSL-RF 3.” 630 In the illustrated example, the baseband bandwidth is divided into three logical parts, each corresponding to one of the CSL-RF units 610, 620, 630. For ease of explanation, the communication over the cables that connect the CSL-IF 605 unit to the three CSL-RF units 610, 620, 630 is assumed to be time-division duplexed (TDD), but the disclosures are not limited to TDD communication. As shown in FIG. 6, between the BBU and the CSL-IF unit 605, the part destined for the CSL-RF unit 1 610 occupies the lowest frequency band, the part destined for the CSL-RF unit 2 620 occupies the next-lowest frequency band between the BBU and CSL-IF unit 605, and the part destined for the CSL-RF unit 3 630 occupies a frequency band that is higher than both of the parts “1” and “2.” In FIG. 6, the parts 1, 2, and 3 are shown as being of unequal sizes, though the sizes of some or all of the parts may alternatively be equal.

Because part 1 already resides at the lowest frequencies, the CSL-IF unit 605 does not need to apply any reallocation to adjust the location of part 1 prior to modulating the baseband signal to IF and transmitting it to CSL-RF unit 610. The CSL-IF 605 could, however, apply a frequency reallocation to reverse the order of parts 2 and 3 in the signal transmitted to CSL-RF unit 1 610. Doing so could be desirable if, for example, the coverage areas covered by (e.g., adjacent building floors) of CSL-RF unit 1 610 and CSL-RF unit 3 630 partially overlap, in which case UEs associated with CSL-RF unit 3 630 might be able to receive signals transmitted by CSL-RF unit 1 610. In this case, it may be desirable to reduce the attenuation of the RBs allocated to CSL-RF unit 3 630 in the signal transmitted to CSL-RF unit 1 610 by the CSL-IF 605 moving part 3 below part 2.

The RBs allocated to CSL-RF unit 2 620 and CSL-RF unit 3 630 are not in the lowest frequency band. Accordingly, the CSL-IF unit 605 determines the frequency reallocations for these two CSL-RF units based at least in part on the frequency boundaries of the three logical parts. Specifically, for the CSL-RF unit 2 620, the CSL-IF unit 605 shifts the transmissions down in frequency by the width of part 1 so that, as a result, part 2 occupies the lowest-frequency band and thereby suffers less attenuation en route to the CSL-RF unit 2 620 than it otherwise would have suffered in its original frequency band. As shown in FIG. 6, parts 1 and 3 are above part 2 following the frequency shift. After the frequency reallocation, part 1 can be above or below part 3 (e.g., for the reason described above in the discussion of CSL-RF unit 1).

Similarly, the frequency reallocation for CSL-RF unit 3 630 results in the third logical part of the baseband bandwidth being shifted to a lower frequency band so that it will experience lower overall attenuation (because of lower wireline attenuation). As shown in FIG. 6, parts 1 and 2 are above part 3 following the frequency reallocation. Part 1 can be above or below part 2 (e.g., for the reason described above in the discussion of CSL-RF unit 1).

One advantage of the frequency reallocation described herein is that it can improve, from the RAN's perspective, the apparent quality of the channel between the RAN and the UEs. For example, the RAN may determine the allocation of RBs to UEs from channel state information (CSI) reports or other measurements/reports from UEs connected via the CSL-IF unit 605. As a result of the frequency reallocation, the attenuation observed by UEs may be lower than it otherwise would have been. For example, referring to FIG. 6, if part 3 were transmitted to the CSL-RF unit 3 630 in its original location, those RBs would arrive at the UEs with a certain attenuation. Because the CSL-IF 605 transmits those RBs to the CSL-RF unit 3 630 in a lower frequency band, however, they arrive at the UEs with lower attenuation. As a consequence, the UEs and the RAN detect a higher-quality (less-attenuated) channel, and the RAN should then give higher preference to the third logical part when allocating RBs for UEs connected via CSL-RF unit 3 630. Thus, the efficiency and performance of the overall communication system can be improved.

In the example of FIG. 6, all three logical parts of the baseband bandwidth are transmitted over the wireline communication path in frequency bands that should have lower attenuation than alternative bands in which they might otherwise be transmitted. It is to be understood that if it is known (e.g., from a channel identification procedure, prior measurements, etc.) that a particular portion of the bandwidth of a particular wireline communication path between the CSL-IF unit 605 and one of the CSL-RF units 610, 620, 630 is more attenuated than expected (e.g., due to a defect in the cable), the disclosed techniques can be used to avoid that portion of the wireline bandwidth.

Note that the CSL-IF unit 605 does not need to know the RB allocations associated with UEs of each CSL-RF unit 610, 620, 630. For the downlink direction, the CSL-IF unit 605 applies different frequency reallocations to downlink signals sent to different CSL-RF units 610, 620, 630 so that, as explained above, lower attenuation is experienced by each of the different sets of RBs for different CSL-RF units. This, in a transparent way, incentivizes the RAN to select a different set of RBs for UEs of CSL-RF units. For instance, the RAN may observe that different one set of RBs has better channel quality (e.g., based on CSI reports, uplink measurements from UEs connected to a CSL, etc.) and may assign to UEs RBs with higher channel quality when possible.

Thus, as shown by the example of FIG. 6, the frequency reallocations create logical parts of bandwidth, each part associated with a respective CSL-RF unit 610, 620. 630. The frequency reallocations may be determined in any suitable way. For example, the reallocations may result in the sizes of the logical parts being equal or unequal, and they may be determined by considering any relevant information, such as, for example, the number of UEs of each CSL-RF unit 610, 620. 630, wireless conditions of the UEs of each CSL-RF unit, traffic requirements of UEs of each CSL-RF unit, etc. For example, reallocations may be determined so that a CSL-RF unit with no UEs may have logical part with zero or very few RBs, whereas a CSL-RF unit with a large number of associated UEs, high traffic requirements, or poor RF conditions may have a logical part with a relatively higher number of RBs.

Although FIG. 6 illustrates TDD communication over the wireline communication paths, it will be appreciated that frequency-division duplexed (FDD) communication could be used instead. In this case, the upstream and downstream bandwidths would differ, but the principles discussed above (and below) would be the same. For example, if the downstream band resides from f₁ to f₂, and the upstream band resides from f₃ to f₄, but other aspects of FIG. 6 still apply, for the downstream direction, the CSL-IF unit 605 could ensure (e.g., by applying one or more individualized frequency reallocations) that part 1 starts at f₁ for transmissions to CSL-RF unit 1 610, part 2 starts at f₁ for transmissions to CSL-RF unit 2 620, and part 3 starts at f₁ for transmissions to CSL-RF unit 3 630. Similarly, in the upstream direction, CSL-RF unit 1 610 could situate part 1 starting at f₃ (possibly by applying a frequency shift), CSL-RF unit 2 620 could situate part 2 starting at f₃ (possibly by applying a frequency shift), and CSL-RF unit 3 630 could situate part 3 starting at f₃ (possibly by applying a frequency shift).

It is to be understood that a CSL-IF unit may be physically connected to multiple CSL-RF units but at times may communicate only with a subset of those CSL-RF units. For example, one or more of the CSL-RF units may be powered off or not serving any UEs at some point in time. Therefore, in some embodiments, subsets of CSL-RF units may be managed by a configuration entity (e.g., the CSL-IF unit) to facilitate an efficient use of available bandwidth. The configuration entity can send messages to the CSL-RF units to instruct them as to how the CSL-RF units should shift their uplink transmissions and/or how the CSL-IF unit will shift its downlink transmissions to the CSL-RF units.

Many messaging approaches are possible. As just one example, the configuration messages can include a count value, c, that indicates a number of CSL-RF units and an index assignment, i, corresponding to each CSL-RF unit. The CSL-RF units can use these values to determine how they should shift their uplink transmissions and/or how the CSL-IF unit will shift its downlink transmissions to them. The count value can reflect, for example, the total number of CSL-RF units connected to the CSL-IF unit, or a number of active CSL-RF units (e.g., a number of CSL-RF units powered on or communicatively coupled to at least one UE). In other words, the count value can reflect some or all of the CSL-RF units that are physically connected to the CSL-IF unit.

As just one example of how the CSL-RF unit can use the count value and index value, if the bandwidth of the baseband signal is denoted as W, and the lowest-value index i is 1, the cyclic shift can be derived by the CSL-RF unit as W×(i−1)/c. The direction of the shift (e.g., left or right) can also be indicated by the configuration message, or it can be pre-arranged (e.g., by convention).

As a specific example in the context of the example configuration shown in FIG. 6, assume the CSL-RF units 1 610 and 2 620 are serving UEs but CSL-RF unit 3 630 is not (e.g., it is powered down or simply not serving any UEs for some reason). Assume further that the CSL-IF unit 605 is the configuration entity. In this case, the CSL-IF unit 605 can send configuration messages to CSL-RF unit 1 610 and CSL-RF unit 2 620 to provide them with a count of active CSL-RF units and an index assigned to them. For example, the CSL-IF unit 605 can send a first configuration message to the CSL-RF unit 1 containing a count value of c=2 and an index assignment of i=1. The CSL-RF unit 1 can then determine, for example, that a (left or right) cyclic shift to be applied in the frequency domain is W×1−12=0, from which the CSL-RF unit 1 610 knows no frequency shift is needed. Similarly, the CSL-IF unit 610 can send a second configuration message to the CSL-RF unit 2 620 containing a count value of c=2 and an index assignment of i=2. The CSL-RF unit 2 620 can then determine, for example, that a (left or right) cyclic shift to be applied in the frequency domain is W×2−12=W/2.

It is to be appreciated that this same messaging approach can be used when all CSL-RF units are active (e.g., serving UEs). For example, if all three CSL-RF units shown in the example of FIG. 6 are active, the CSL-IF unit (or another configuration entity) can send messages to all of the CSL-RF units to indicate that the count value c=3c=3 and to assign them indices. The frequency shift applied by the CSL-RF unit assigned i=1 would be W×1−13=0, the frequency shift applied by the CSL-RF unit assigned i=2 would be W×2−13=13W, and the frequency shift applied by the CSL-RF unit assigned i=3 would be W×3−13=23W. It is to be appreciated that the count value cc, the index value ii, and the function W×(i−1)/c are only one example of how the frequency shift can be communicated by a configuration entity and applied by the CSL-RF unit, and that other approaches are possible and are within the scope of the disclosures herein.

As explained above, the frequency reallocations used by the CSL-IF unit 605 and/or CSL-RF units 610, 620, 630 may be implemented, for example, by cyclic shifts, by non-cyclic shifts, or in any other manner that allows the parts to be situated as desired in frequency.

The frequency reallocations may be determined by a configuration entity, which may be, for example, the CSL-IF unit 605 or a remote entity (e.g., in the cloud). Information about the frequency reallocations to be applied (or to be applied) in the uplink and downlink directions can be communicated, for example, by a cloud-based entity to the CSL-IF unit 605 and/or CSL-RF units 610, 620, 630. As another example, if the CSL-IF unit 605 determines the uplink and/or downlink frequency reallocations, the CSL-IF unit 605 can send information describing the frequency reallocation(s) to the CSL-RF units 610, 620, 630. In another example, the CSL-RF units 605 can determine the uplink frequency reallocations they will apply (or are applying) and send information to the CSL-IF unit 605 to describe the frequency reallocations. The frequency reallocation applied by the CSL-IF unit 605 and the CSL-RF units 610, 620, 630 is transparent to both the BBE/BBU and the UEs. The CSL-IF and CSL-RF units can communicate their frequency reallocations and/or changes in their frequency reallocations using an overhead channel (e.g., in-band or out of band).

Each CSL-RF unit 610, 620, 630 knows the frequency reallocation that its connected CSL-IF unit 605 applies to downlink signals so that the CSL-RF unit can undo (reverse) the frequency reallocation applied by the CSL-IF unit before the CSL-RF unit generates RF signals for transmission to the UEs. Similarly, the CSL-IF unit 605 knows the frequency reallocation applied to uplink signals by each of its connected CSL-RF units 610, 620, 630 so that the CSL-IF unit can undo each CSL-RF unit's frequency reallocation before the CSL-IF unit generates uplink signals sent to the BBU. The information regarding frequency reallocations in the uplink and/or downlink directions can be shared between the CSL-IF unit 605 and the CSL-RF units 610, 620, 630, for example, during an initialization procedure, or using control channels between the CSL-IF unit and each CSL-RF unit, or in any other suitable way.

It is to be understood that it is not necessary that each logical part of the baseband bandwidth be shifted. For example, referring to FIG. 6, as explained above, the part labeled 1 can remain in its location (e.g., either its absolute location or its location relative to the parts 2 and 3).

It is also to be understood that the techniques described in the discussions of FIG. 5 and FIG. 6 can be used individually or jointly. Unlike the wireless resources shared by CSL-RF units, the wireline media between the CSL-IF unit and each CSL-RF unit are separate, dedicated resources, and thus their frequency allocations can be individually managed to improve the efficiency and performance of the overall system. Different frequency reallocations can be used for different wireline communication paths.

Accordingly, in some embodiments, an intermediate transceiver (e.g., a CSL-IF unit) receives a downlink signal that comprises a first part for delivery to a first distribution transceiver (e.g., a first CSL-RF unit) and a second part for delivery to a second distribution transceiver (e.g., a second CSL-RF unit). The first and second parts of the downlink signal occupy disjointed frequency bands (e.g., for a multicarrier system, the first part uses a first set of subchannels, and the second part uses a different set of subchannels, none of which are included in the first set of subchannels), with the first part occupying a first frequency band and the second part occupying a second frequency band, where the first frequency band is assumed to occupy a lower-frequency band than the second frequency band.

The first distribution transceiver is coupled to the intermediate transceiver by a first wireline communication path (e.g., a first cable), and the second distribution transceiver is coupled to the intermediate transceiver by a second wireline communication path (e.g., a second cable). Referring to FIG. 6, the first distribution transceiver could be, for example, CSL-RF 1 610, and the second distribution transceiver could be, for example, either CSL-RF 2 620 or CSL-RF 3 630. As another example in the context of FIG. 6, the first distribution transceiver could be CSL-RF 2 620, and the second distribution transceiver could be CSL-RF 3 630.

Because the second part of the baseband signal occupies a frequency band that is likely to be more severely attenuated by the second wireline path than it would be if it occupied a lower-frequency band, the intermediate transceiver may apply a frequency reallocation to the downlink signal to create an alternative baseband signal for transmission to the second distribution unit in which the second part occupies a lowest-frequency band of the baseband bandwidth. This alternative baseband signal has a baseband bandwidth that may be the same as or different from the bandwidth of the downlink signal. For example, the baseband bandwidth of the alternative baseband signal may be the same as the bandwidth of the downlink signal if the intermediate transceiver applies some type of (cyclic or non-cyclic) frequency shift to create the alternative baseband signal as described above (e.g., in the discussion of FIG. 6).

In some embodiments, after the frequency reallocation, the first part of the downlink signal occupies a higher-frequency band of the baseband bandwidth, where the higher-frequency band begins above the lowest-frequency band. In other words, in some embodiments, the relative positions of the first and second portions of the downlink signal are reversed following the frequency reallocation.

Alternatively, the baseband bandwidth of the alternative baseband signal may be different from the baseband bandwidth of the downlink signal if the intermediate transceiver removes part of the downlink signal when creating the alternative baseband signal as described above (e.g., in the discussion of FIG. 5).

The intermediate transceiver then transmits the alternative baseband signal to the second distribution transceiver over the second wireline communication path (e.g., by upconverting it to a desired frequency band and transmitting the upconverted signal). The intermediate transceiver can send the original, unmodified baseband signal as-is to the first distribution transceiver (after up-conversion to the appropriate intermediate frequency), or it can modify the signal (e.g., remove higher-frequency portions that are not needed by or useful to the first distribution transceiver).

When an intermediate transceiver (e.g., a CSL-IF unit) is connected to additional distribution transceivers (e.g., CSL-RF units), the intermediate transceiver can apply appropriate (“customized”) frequency reallocations for each of the additional distribution transceivers in the manner described above. For example, in addition to the first and second parts, the downlink signal may also have a third part, destined for a third distribution transceiver. This third part may occupy a third frequency band that is disjoint from and higher than both the first and second frequency bands. The intermediate transceiver can apply another frequency reallocation to the downlink signal to create a second alternative baseband signal for transmission to the third distribution transceiver. This second alternative baseband signal has a second baseband bandwidth, which could be the same as or different from the bandwidth of the downlink signal. In this second alternative baseband signal, the third part of the downlink signal occupies a lowest-frequency band of the second baseband bandwidth. This second baseband signal can then be transmitted (e.g., following upconversion to an intermediate frequency) to the third distribution transceiver that is awaiting the third part of the downlink signal. For example, referring to FIG. 6, if CSL-RF 1 610 is the first distribution transceiver, and CSL-RF 2 620 is the second distribution transceiver, then the CSL-RF 3 630 can be the third distribution transceiver.

A similar procedure can take place in the uplink direction, either in addition or alternatively. In some embodiments, an intermediate transceiver (e.g., a CSL-IF unit) is coupled to a first distribution transceiver (e.g., a first CSL-RF unit) over a first wireline communication path and to a second distribution transceiver (e.g., a second CSL-RF unit) over a second wireline communication path. The intermediate transceiver receives a first uplink signal from the first distribution transceiver over the first wireline communication path and a second uplink signal from the second distribution transceiver over the second wireline communication path. The first uplink signal comprises a first part occupying a first upstream frequency band, and the second uplink signal comprises a second part occupying a second upstream frequency band, where the first upstream frequency band and the second upstream frequency band at least partially overlap. For example, at baseband, the first part may occupy a first low-frequency band (e.g., spanning from DC or near DC to a first upper frequency), and the second part may occupy a second low-frequency band (e.g., spanning from DC or near DC to a second upper frequency).

The first and second low-frequency bands can be the same, or they can be different. For example, the first and second distribution transceivers may transmit uplink signals in the same frequency band, e.g., the uplink signals of both distribution transceivers may start at some frequency, f₁, and end at an upper frequency, f₂. The frequencies f₁ and f₂ may be chosen, for example, to reduce or minimize attenuation of the signals caused by the first and second wireline communication paths (e.g., the start frequency f₁ may be at or near zero) while still providing enough bandwidth for uplink signals.

In general, the first distribution transceiver can transmit signals to the intermediate transceiver in a frequency band from f₁ to f₂, and the second distribution transceiver can transmit signals to the intermediate transceiver in a frequency band from f₃ to f₄. The values of f₁ and f₃ may be the same or different. Likewise, the values of f₂ and f₄ may be the same or different. The values of f₁, f₂, f₃, and f₄ may be chosen to reduce or minimize attenuation of the signals caused by the first and second wireline communication paths (e.g., the start frequencies f₁ and f₃ may be at or near zero and the end frequencies f₂ and f₄ may be only as high as needed) while still providing enough bandwidth for uplink signals. Characteristics of the individual wireline communication paths (e.g., defects causing differences in attenuation, different materials, different cable types, etc.) and/or interference to or from other devices and/or systems can also be considered in selecting the values of f₁, f₂, f₃, and f₄. For example, if the first wireline communication path and the second wireline communication path are physically close together such that transmissions on one can cause interference or crosstalk to the other (e.g., they are twisted pairs that can suffer from near-end or far-end crosstalk), the frequency bands used upstream can be selected to account for the interference.

The intermediate transceiver may create a third uplink signal from the first uplink signal and the second uplink signal (e.g., after down-converting one or both uplink signals). For example, the intermediate transceiver may apply a frequency reallocation to the first uplink signal and/or the second uplink signal so that in the third uplink signal, the first and second parts occupy disjoint (non-overlapping) frequency bands (e.g., the first part occupies a third upstream frequency band and the second part occupies a fourth upstream frequency band, wherein the third upstream frequency band and the fourth upstream frequency band are non-overlapping). Following the frequency allocation, at least one of the first part or the second part will be in a different frequency band relative to its location in the first and second uplink signals. For example, in some embodiments the first upstream frequency band and the third upstream frequency band are substantially identical, and the second frequency band and the fourth frequency band are different. As another example, in some embodiments, the first upstream frequency band and the third upstream frequency band are different, and the second frequency band and the fourth frequency band are different.

After creating the third uplink signal, the intermediate transmitter may send the third uplink signal to an upstream entity, such as a base station (e.g., a BBU). The transmission may take place over a wireless or wired communication path. In some embodiments, transmitting the third uplink signal to the base station of the wireless communication path comprises upconverting the third uplink signal. In some embodiments, before the intermediate transceiver upconverts the third uplink signal, the third upstream frequency band is identical to the first upstream frequency band, and the fourth upstream frequency band and the second upstream frequency band are different.

Thus, in some embodiments, a system is provided to support downlink communications between an intermediate transceiver (e.g., a CSL-IF unit) and a first distribution transceiver (e.g., a first CSL-RF unit) coupled to the intermediate transceiver by a first wireline communication path, and between the intermediate transceiver and a second distribution transceiver (e.g., a second CSL-RF unit) coupled to the intermediate transceiver by a second wireline communication path. In some embodiments, the intermediate transceiver is configured to receive a downlink signal comprising a first part for delivery to the first distribution transceiver over the first wireline communication path and a second part for delivery to the second distribution transceiver over the second wireline communication path, wherein the first part occupies a first frequency band and the second part occupies a second frequency band, the first and second frequency bands being disjoint (non-overlapping), and the first frequency band being lower than the second frequency band; apply a frequency reallocation to the downlink signal to create a baseband signal having a baseband bandwidth, wherein the second part occupies a lowest-frequency band of the baseband bandwidth; and transmit the baseband signal to the second distribution transceiver over the second wireline communication path. In some embodiments, the intermediate transceiver is configured to transmit the baseband signal to the second distribution transceiver by upconverting the baseband signal, and transmitting the upconverted baseband signal to the second distribution transceiver. In some embodiments, following the frequency reallocation, the first part occupies a higher-frequency band of the baseband bandwidth, the higher-frequency band beginning above the lowest-frequency band.

In some embodiments, the downlink signal further comprises a third part occupying a third frequency band that is disjoint from and higher than both the first and second frequency bands, and the intermediate transceiver is further configured to apply a second frequency reallocation to the downlink signal to create a second baseband signal having a second baseband bandwidth such that the third part occupies a lowest-frequency band of the second baseband bandwidth; and transmit the second baseband signal to a third distribution transceiver over a third wireline communication path (e.g.., by upconverting the second baseband signal and transmitting the upconverted second baseband signal to the third distribution transceiver.

In some embodiments, a system is provided to support upstream communications between an intermediate transceiver (e.g., a CSL-IF unit) and a first distribution transceiver (e.g., a first CSL-RF unit) coupled to the intermediate transceiver by a first wireline communication path, and between the intermediate transceiver and a second distribution transceiver (e.g., a second CSL-RF unit) coupled to the intermediate transceiver by a second wireline communication path. In some embodiments, the intermediate transceiver is configured to receive a first uplink signal from the first distribution transceiver over the first wireline communication path, the first uplink signal comprising a first part occupying a first upstream frequency band; receive a second uplink signal from the second distribution transceiver over the second wireline communication path, the second uplink signal comprising a second part occupying a second upstream frequency band, wherein the first upstream frequency band and the second upstream frequency band at least partially overlap; create an aggregate uplink signal from the first uplink signal and the second uplink signal; and transmit the aggregate uplink signal to a base station (e.g., a BBU) over a wireless communication path. In some embodiments, creating the aggregate uplink signal comprises applying one or more frequency reallocations to at least one of the first uplink signal or the second uplink signal so that, in the aggregate uplink signal, the first part occupies a third upstream frequency band and the second part occupies a fourth upstream frequency band, wherein the third upstream frequency band and the fourth upstream frequency band are non-overlapping. In some embodiments, the first upstream frequency band and the third upstream frequency band are substantially identical, and the second frequency band and the fourth frequency band are different. In other embodiments, the first upstream frequency band and the third upstream frequency band are different, and the second frequency band and the fourth frequency band are different. In some embodiments, creating the aggregate uplink signal further comprises down converting the first uplink signal and/or the second uplink signal.

A system can be provided to allow uplink and/or downlink communication between an intermediate transceiver (e.g., a CSL-IF unit) and a plurality of N distribution transceivers (e.g., each a CSL-RF unit), where N is an integer greater than or equal to 2, each of which is coupled to the intermediate transceiver by a respective one of N wireline communication paths. For downlink communication, the intermediate transceiver can be configured to receive a downlink signal that includes a plurality of N downlink parts occupying a respective plurality of N frequency bands, all of which are disjoint (non-overlapping).

Each of the N downlink parts is associated with (and is for delivery to) a respective one of the N distribution transceivers. The intermediate transceiver can be configured to apply one or more frequency reallocations to the downlink signal to create a plurality of N baseband signals from the downlink signal. In some embodiments, an ordering of the plurality of N downlink parts in a first baseband signal of the plurality of baseband signals differs from an ordering of the plurality of N downlink parts in a second baseband signal of the plurality of baseband signals. The intermediate transceiver can also be configured to transmit each of the plurality of N baseband signals to a respective one of the plurality of N distribution transceivers over the respective one of the N wireline communication paths (e.g., by upconverting each of the plurality of N baseband signals and transmitting the plurality of N upconverted baseband signals to the plurality of N distribution transceivers). Some or all of the plurality of N distribution transceivers can be configured to receive and process respective baseband signals from the intermediate transceiver. For example, in some embodiments, at least one of the plurality of N distribution transceivers is configured to receive a respective one of the plurality of N baseband signals, and create a restored baseband signal. A distribution transceiver may create its respective restored baseband signal by, for example, removing at least a portion of the one or more frequency reallocations from its received respective one of the plurality of N baseband signals (e.g., by applying a cyclic or non-cyclic frequency shift).

The distribution transceiver may perform the removal based on or using information provided by a configuration entity that was responsible for or involved in determining the frequency reallocation applied to the one of the plurality of N baseband signals. The configuration entity may be, for example, the intermediate transceiver, a base station (e.g., a BBU), a cloud-based management entity, etc. The distribution transceiver may downconvert the received respective one of the plurality of N baseband signals before removing any frequency reallocation that the intermediate transceiver applied to create the received respective one of the plurality of N baseband signals. The distribution transceiver may then upconvert the restored baseband signal, e.g., for transmission to one or more UEs it is serving.

The above-described system can be configured to support communication in the uplink direction, either in addition or alternatively. For example, the intermediate transceiver can be configured to receive a plurality of N uplink signals from the plurality of N distribution transceivers, create an aggregate uplink signal from the plurality of N uplink signals, and transmit the aggregate uplink signal to a base station over a wireless communication path. In some embodiments, the intermediate transceiver is configured to create the aggregate uplink signal by applying one or more frequency reallocations to at least a portion of the plurality of N uplink signals, which may occur before or after down-converting at least one, and potentially all, of the plurality of N uplink signals.

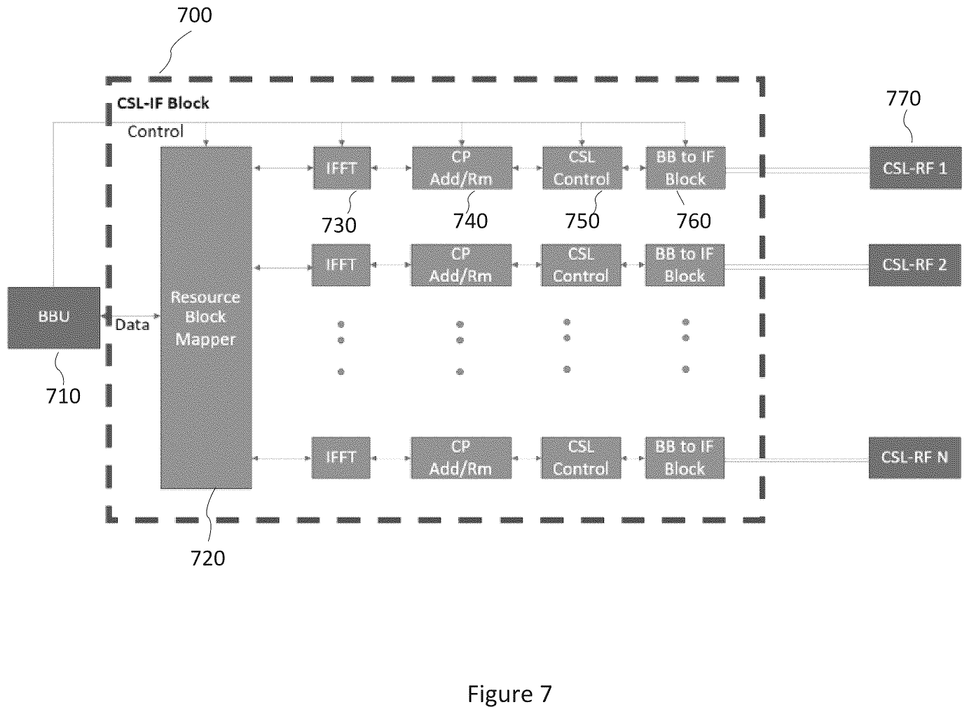

FIG. 7 illustrates an exemplary CSL-IF block according to various embodiments of the invention. As shown the CSL-IF block 700 is coupled to a baseband unit 710 and receives downlink data/control information and transmits uplink data/control information. A resource block mapper 720 is coupled within the CSL-IF block 700 and manages resource block frequency shift across for one or more CSL-RF 770 blocks. The resource block mapper 720 divides available frequency spectrum into sub-blocks as previously discussed. This division of spectrum into the sub-blocks allows the resource block mapper to provide a frequency shift across at least one of the sub-blocks prior to transmission on the wireline. As previously discussed, the frequency shift allows the system to influence a scheduler within a wireless device, such as a cellular base station or WiFi access point, to schedule resource blocks within a particular sub-block(s) to one or more CSL-RF devices. This frequency shift allows an improved bandwidth management within a wireline portion because the channel estimation information received by the scheduler will be influenced by the frequency shift on the wireline portion of the system between the CSL-IF block 700 and one or more CSL-RF blocks 770.

In certain embodiments, the resource block mapper 720 partitions a frequency range into a plurality of sub-block of frequencies and assigns at least one of the sub-blocks to a particular CSL-RF device 770. Frequencies outside of this assigned sub-block are shifted higher by a preferred amount such that these shifted frequencies will experience meaningful attenuation and/or degradation as they propagate along the wireline portion. As channel estimation processes are performed for channels between a cellular base station/wireless access point and a wireless device within a network associated with the particular CSL-RF device 770, channels that are frequency shifted to higher spectra appear to have poor channel qualities to a scheduler. As a result, the scheduler will assign resource blocks for the wireless device (both uplink and downlink) within the preferred frequency sub-block(s).

One or more transmission paths are defined within the CSL-IF block 700. As shown, exemplary transmission paths comprise an inverse fast Fourier transform block (IFFT) 730 that coverts a received signal from a frequency domain vector signal to a time domain vector signal. A control plane add/remove block 740 adds control information into a downlink signal that enables a CSL-RF device 770 to properly process the signal. In certain embodiments, frequency shift information is also included so that the defined shift is performed prior to transmission on the wireline connection. In this particular instance, a CSL control block 750 processes this frequency shift information and identifies the magnitude and direction of the shift. This frequency shift information is provided to a baseband to intermediate frequency block 760 such that the signals transmitted on the wireline are adapted in accordance with the identified frequency shift across the sub-block(s) is implemented. Accordingly, when channel estimation processes are applied across the wireless-wireline connection, frequencies that are shifted higher will generate relatively poor channel quality while frequencies that are not shifted will indicate relatively higher quality (or at least a portion of these un-shifted channels).

In other embodiments, the frequency shift information is also communicated on discrete control connections from the resource block mapper 720 to one or more of the other blocks 730, 740, 750 and 760 within the CSL-IF block 700.

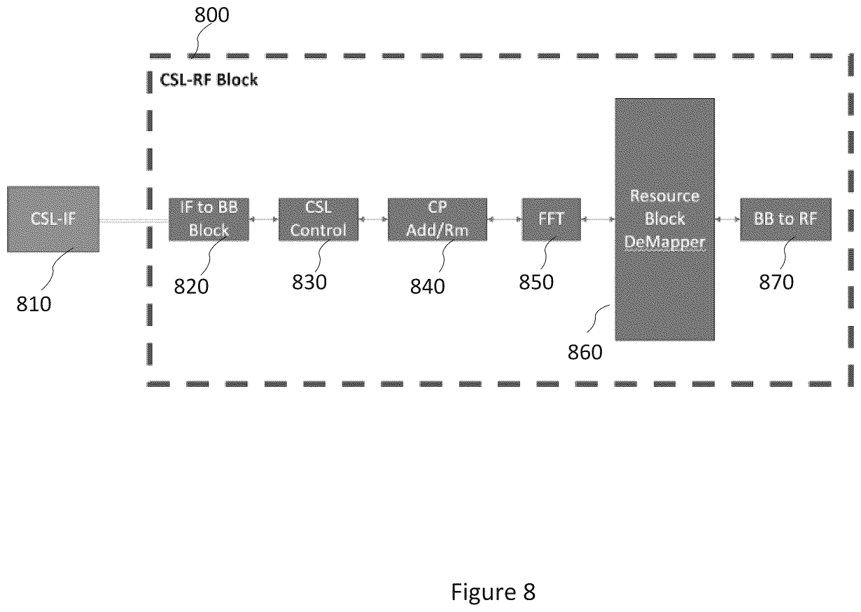

FIG. 8 illustrates an exemplary CL-RF block according to various embodiments of the invention. As shown, the CSL-RF block 800 is coupled to transmit and receive data/control information within a CSL-IF block 810. This CSL-RF block 800 is able to reverse frequency shifting performed on downlink signals and perform frequency shifting on uplink signals.

Referencing a downlink signal, an intermediate frequency to baseband block 820 converts the received downlink signal to a corresponding baseband signal. A CSL control block 830 analyzes control information embedded within the signal. In certain embodiments, this CSL control block 830 identifies frequency shift information corresponding to the signal and communicates this information to a subsequent block(s). This frequency shift information may be embedded within the signal (as shown) or may be communicated by discrete control lines (not shown). A control plane add/remove block 840 removes at least a portion of the control information that had been inserted by the CSL-IF device 810. A fast Fourier transform block 850 converts the signal from a time domain vector signal to a frequency domain vector signal. A resource block demapper 860 receives the frequency shift information and performs a reverse frequency shift relative to the shift performed by the CSL-IF 810. For example, if a sub-block frequency is shifted higher by the CSL-IF 810, then the resource block demapper 860 performs a lower frequency shift equal in magnitude to the frequency shift performed by the CSL-IF 810. A baseband to radio frequency block 870 generates a radio frequency that is subsequently transmitted to wireless devices within the cell or WiFi network.

One skilled in the art will recognize that the higher frequency shift by the CSL-IF 810 and corresponding lower frequency shift by the CSL-RF 800 is transparent to both the cellular/WiFi scheduler and the UE/wireless device. However, these frequency shifts take advantage of the transmission characteristics of the wireline portion of the connection to increase the probability of the scheduler to assign resource blocks within a preferred sub-block of frequencies that correspond to a particular CSL-RF.

It is to be understood that although the disclosures herein are largely in the context of CSL and a wireless-wireline converged architecture, the disclosures are not limited to the described environments or applications. It will be appreciated by those having ordinary skill in the art that operations such as upconversion and downconversion may take place as desired to position the bandwidth of a signal in a desired location of the spectrum for transmission to/from the intermediate transceiver (e.g., CSL-IF unit) and/or for transmission to/from the distribution transceiver(s) (e.g., CSL-RF unit(s)).

Furthermore, although certain 3GPP/cellular terminology and acronyms or initialisms are used herein (e.g., RB, BBU, RAN, MCS, UE, etc.), those having ordinary skill in the art will understand that other terms may be used in other contexts (e.g., Wi-Fi, IEEE 802.11 standards, etc.). For example, in multi-carrier systems (such as those that use orthogonal frequency division multiplexing or discrete multitone modulation), a resource block (which may also be referred to as a resource element) is simply a quantity of time and frequency that can be assigned to a device. It is to be appreciated that resources allocated for communication over a channel can be described in other ways.

In the foregoing description and in the accompanying drawings, specific terminology has been set forth to provide a thorough understanding of the disclosed embodiments. In some instances, the terminology or drawings may imply specific details that are not required to practice the invention.

To avoid obscuring the present disclosure unnecessarily, well-known components are shown in block diagram form and/or are not discussed in detail or, in some cases, at all.

Unless otherwise specifically defined herein, all terms are to be given their broadest possible interpretation, including meanings implied from the specification and drawings and meanings understood by those skilled in the art and/or as defined in dictionaries, treatises, etc. As set forth explicitly herein, some terms may not comport with their ordinary or customary meanings.

As used herein, the singular forms “a,” “an” and “the” do not exclude plural referents unless otherwise specified. The word “or” is to be interpreted as inclusive unless otherwise specified. Thus, the phrase “A or B” is to be interpreted as meaning all of the following: “both A and B,” “A but not B,” and “B but not A.” Any use of “and/or” herein does not mean that the word “or” alone connotes exclusivity.

The terms “exemplary” and “embodiment” are used to express examples, not preferences or requirements. The term “coupled” is used herein to express a direct connection/attachment as well as a connection/attachment through one or more intervening elements or structures.

Although specific embodiments have been disclosed, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

The foregoing description of the invention has been described for purposes of clarity and understanding. It is not intended to limit the invention to the precise form disclosed. Various modifications may be possible within the scope and equivalence of the appended claims.

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and methods, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

What is claimed is:

1. A method performed by an intermediate transceiver, the method comprising:
receiving a downlink signal, the downlink signal comprising a first part for delivery to a first distribution transceiver coupled to the intermediate transceiver by a first wireline communication path and a second part for delivery to a second distribution transceiver coupled to the intermediate transceiver by a second wireline communication path, wherein the first part occupies a first frequency band and the second part occupies a second frequency band, the first and second frequency bands being disjoint, the first frequency band being lower than the second frequency band;
applying a frequency reallocation to the downlink signal to create a baseband signal having a baseband bandwidth, wherein the second part occupies a lowest-frequency band of the baseband bandwidth; and
transmitting the baseband signal to the second distribution transceiver over the second wireline communication path.

2. The method of claim 1, wherein transmitting the baseband signal to the second distribution transceiver comprises:
upconverting the baseband signal, and
transmitting the upconverted baseband signal to the second distribution transceiver.

3. The method of claim 1, wherein, following the frequency reallocation, the first part occupies a higher-frequency band of the baseband bandwidth, the higher-frequency band beginning above the lowest-frequency band.

4. The method of claim 1, wherein the frequency reallocation is a first frequency reallocation, the baseband signal is a first baseband signal, the baseband bandwidth is a first baseband bandwidth, and wherein the downlink signal further comprises a third part occupying a third frequency band, the third frequency band being disjoint from and higher than both the first and second frequency bands, and wherein the method further comprises:
applying a second frequency reallocation to the downlink signal to create a second baseband signal having a second baseband bandwidth, wherein the third part occupies a lowest-frequency band of the second baseband bandwidth; and
transmitting the second baseband signal to a third distribution transceiver over a third wireline communication path.

5. The method of claim 4, wherein transmitting the second baseband signal to the third distribution transceiver comprises:
upconverting the second baseband signal, and
transmitting the upconverted second baseband signal to the third distribution transceiver.

6. The method of claim 1, wherein the frequency reallocation is a first frequency reallocation, and further comprising:
receiving a first uplink signal from the first distribution transceiver over the first wireline communication path, the first uplink signal comprising a third part occupying a first upstream frequency band;
receiving a second uplink signal from the second distribution transceiver over the second wireline communication path, the second uplink signal comprising a fourth part occupying a second upstream frequency band, the first upstream frequency band and the second upstream frequency band at least partially overlapping;
creating a third uplink signal from the first uplink signal and the second uplink signal, wherein creating the third uplink signal comprises applying a second frequency reallocation to at least one of the first uplink signal or the second uplink signal, wherein, in the third uplink signal, the third part occupies a third upstream frequency band and the fourth part occupies a fourth upstream frequency band, wherein the third upstream frequency band and the fourth upstream frequency band are non-overlapping; and
transmitting the third uplink signal to a base station over a wireless communication path.

7. The method of claim 1, wherein the intermediate transceiver comprises a cellular subscriber line intermediate-frequency (CSL-IF) unit, the first distribution transceiver comprises a first CSL radio-frequency (CSL-RF) unit, and the second distribution transceiver comprises a second CSL-RF unit.

8. A method performed by an intermediate transceiver coupled to a first distribution transceiver over a first wireline communication path and to a second distribution transceiver over a second wireline communication path, the method comprising:
receiving a first uplink signal from the first distribution transceiver over the first wireline communication path, the first uplink signal comprising a first part occupying a first upstream frequency band;
receiving a second uplink signal from the second distribution transceiver over the second wireline communication path, the second uplink signal comprising a second part occupying a second upstream frequency band, wherein the first upstream frequency band and the second upstream frequency band at least partially overlap;
creating a third uplink signal from the first uplink signal and the second uplink signal, wherein creating the third uplink signal comprises applying a frequency reallocation to at least one of the first uplink signal or the second uplink signal, wherein, in the third uplink signal, the first part occupies a third upstream frequency band and the second part occupies a fourth upstream frequency band, wherein the third upstream frequency band and the fourth upstream frequency band are non-overlapping; and
transmitting the third uplink signal to a base station over a wireless communication path.

9. The method of claim 8, wherein the first upstream frequency band and the third upstream frequency band are substantially identical, and the second frequency band and the fourth frequency band are different.

10. The method of claim 8, wherein the first upstream frequency band and the third upstream frequency band are different, and the second frequency band and the fourth frequency band are different.

11. The method of claim 8, wherein creating the third uplink signal further comprises down-converting at least one of the first uplink signal or the second uplink signal.

12. The method of claim 8, wherein transmitting the third uplink signal to the base station of the wireless communication path comprises upconverting the third uplink signal.

13. A system, comprising:
an intermediate transceiver; and
a plurality of N distribution transceivers, each of the plurality of N
distribution transceivers coupled to the intermediate transceiver by a respective one of N wireline communication paths;
and wherein the intermediate transceiver is configured to:
receive a downlink signal, the downlink signal comprising a plurality of N downlink parts occupying a respective plurality of N frequency bands, each of the plurality of N downlink parts associated with a respective one of the plurality of N distribution transceivers, each of the plurality of N frequency bands occupying a disjoint frequency band;
create a plurality of N baseband signals, wherein creating the plurality of N baseband signals comprises applying one or more frequency reallocations to the downlink signal, wherein an ordering of the plurality of N downlink parts in a first baseband signal of the plurality of baseband signals differs from an ordering of the plurality of N downlink parts in a second baseband signal of the plurality of baseband signals; and
transmit each of the plurality of N baseband signals to a respective one of the plurality of N distribution transceivers over the respective one of the N wireline communication paths.

14. The system of claim 13, wherein the intermediate transceiver is configured to transmit each of the plurality of N baseband signals to the respective one of the plurality of N distribution transceivers at least in part by:
upconverting the plurality of N baseband signals; and
transmitting the plurality of N upconverted baseband signals to the plurality of N distribution transceivers.

15. The system of claim 13, wherein the intermediate transceiver comprises a cellular subscriber line intermediate-frequency (CSL-IF) unit, and each of the plurality of N distribution transceivers comprises a CSL radio-frequency (CSL-RF) unit.

16. The system of claim 13, wherein at least one of the plurality of N distribution transceivers is configured to:
receive a respective one of the plurality of N baseband signals; and
create a restored baseband signal, wherein creating the restored baseband signal comprises removing at least a portion of the one or more frequency reallocations from the received respective one of the plurality of N baseband signals.

17. The system of claim 16, wherein the at least one of the plurality of N distribution transceivers is configured to remove the at least a portion of the one or more frequency reallocations from the received respective one of the plurality of N baseband signals based at least in part on information provided by a configuration entity responsible for determining, at least in part, the at least a portion of the one or more frequency reallocations.

18. The system of claim 17, wherein the configuration entity comprises the intermediate transceiver, a base station, or a cloud-based management entity.

19. The system of claim 17, wherein the information provided by the configuration entity further comprises an indication of a frequency shift direction.

20. The system of claim 13, wherein the intermediate transceiver comprises a cellular subscriber line intermediate-frequency (CSL-IF) unit, and each of the plurality of N distribution transceivers comprises a CSL radio-frequency (CSL-RF) unit.
